(19) United States
(12) Patent Application Publication
(10) Pub. No.: US 2017/0171605 A1
(43) Pub. Date: Jun. 15, 2017

(54) Method and Electronic Device for Switching Live Broadcast to On-Demand Unicast

(71) Applicants: Le Holdings (Beijing) Co., Ltd., Beijing (CN); Le Shi Zhi Xin Electronic Technology (Tianjin) Limited, Tianjin (CN)

(72) Inventor: Xiujing Li, Tianjin (CN)

(21) Appl. No.: 15/243,215

(22) Filed: Aug. 22, 2016

Related U.S. Application Data
(63) Continuation of application No. PCT/CN2016/088451, filed on Jul. 4, 2016.

(30) Foreign Application Priority Data
Dec. 15, 2015 (CN) 2015109399308

(51) Int. Cl. H04N 21/438; H04N 21/858; H04N 21/472; H04N 21/6408

(52) U.S. Cl. CPC H04N 21/4383; H04N 21/6408; H04N 21/8586; H04N 21/47202

(57) ABSTRACT

Disclosed are a data download method and electronic device for switching live broadcast to on-demand unicast includes: acquiring an instruction for switching live broadcast to on-demand unicast input by a user based on a rebroadcasting station, the instruction for switching live broadcast to on-demand unicast including a name of an on-demand video and an episode number of the on-demand video; sending the instruction for switching live broadcast to on-demand unicast to a server, and indicating the server to return on-demand video parameters according to the instruction for switching live broadcast to on-demand unicast; and after the on-demand video parameters are acquired, playing the corresponding on-demand video according to the on-demand video parameters. According to the method, only a one-step operation is needed to ensure that the client can obtain a corresponding on-demand video from the server and can quickly and accurately switch to on-demand play content.

### CROSS REFERENCE TO RELATED APPLICATIONS

This application is a continuation of International Application No. PCT/CN2016/088451, filed Jul. 4, 2016, and claims priority to Chinese Patent Application No. 2015109399308, filed Dec. 15, 2015, the disclosures of which are hereby incorporated in their entirety by reference.

### TECHNICAL FIELD

The present disclosure relates to the technical field of video playing, and specifically relates to a method and electronic device for switching live broadcast to on-demand unicast.

### BACKGROUND

The existing “rebroadcasting station” is a distinctive television station in which the hottest programs at present are carefully selected for users from massive video libraries by editors, and are played in accordance with a time sequence. If the user has not decided what content to be searched temporarily, he can watch the rebroadcasting station. In order to meet the needs of the users with the different hobbies, the rebroadcasting station can have multiple programs, including a general channel, a movie channel, a television play channel, an animation channel, a sports channel, a documentary channel, a television station 1080p and a music channel etc., and is easy to watch, and fast and convenient for channel change. The carousel channels of the rebroadcasting station initiate 7×24 hours playing of a great number of major channels for the first time in the whole world, and achieve “millisecond” switching from live broadcast to on-demand unicast.

The rebroadcasting station (live broadcast content) can be switched to corresponding on-demand content for playing, specifically, for example, the rebroadcasting station is playing the 10^{th} episode of a television play “I'm Hao Congming” currently, and the steps for switching to on-demand unicast of the 10^{th} episode are as follows:

1), selecting the episode played currently, for example the 10^{th} episode of “I'm Hao Congming”, specifically as shown in FIG. 1;

2), pressing an OK button to enter a TV version for playing a corresponding on-demand television play, specifically as shown in FIG. 2;

3), selecting the 10^{th} episode, specifically as shown in FIG. 3; and

4), confirming to play from the start, specifically as shown in FIG. 4.

In the process of implementing the present disclosure, the inventor finds that there are at least the following problems in the prior art:

1, the operation is complicated.

2, the selected episode, for example, the 10^{th} or 11^{th} episode of “I'm Hao Congming”, cannot be immediately positioned when a user presses the OK button.

### SUMMARY

In order to overcome the defect that the interaction process in the existing technology for switching live broadcast to on-demand unicast is too complicated, according to one aspect of the present disclosure, a method for switching live broadcast to on-demand unicast is provided.

A method for switching live broadcast to on-demand unicast, provided by an embodiment of the present disclosure, includes: acquiring an instruction for switching live broadcast to on-demand unicast input by a user based on a rebroadcasting station, wherein the instruction for switching live broadcast to on-demand unicast includes a name of an on-demand video and an episode number of the on-demand video, or also includes definition and/or a type of the on-demand video; sending the instruction for switching live broadcast to on-demand unicast to a server, and indicating the server to return on-demand video parameters according to the instruction for switching live broadcast to on-demand unicast, wherein the on-demand video parameters include a play URL of a corresponding on-demand video; and after the on-demand video parameters are acquired, playing the corresponding on-demand video according to the on-demand video parameters.

Based on the same inventive conception, an embodiment of the present disclosure also provides an electronic device, comprising: at least one processor; and a memory communicably connected with the at least one processor for storing instructions executable by the at least one processor, wherein execution of the instructions by the at least one processor causes the at least one processor to: acquiring an instruction for switching live broadcast to on-demand unicast input by a user based on a rebroadcasting station, wherein the instruction for switching live broadcast to on-demand unicast comprises a name of an on-demand video and an episode number of the on-demand video, or also comprises definition and/or a type of the on-demand video; sending the instruction for switching live broadcast to on-demand unicast to a server, and indicating the server to return on-demand video parameters according to the instruction for switching live broadcast to on-demand unicast, wherein the on-demand video parameters comprise a play Uniform Resource Locator URL of a corresponding on-demand video; and after the on-demand video parameters are acquired, playing the corresponding on-demand video according to the on-demand video parameters.

Based on the same inventive conception, an embodiment of the present disclosure also provides a non-transitory computer-readable storage medium storing executable instructions that, when executed by an electronic device, cause the electronic device to: acquiring an instruction for switching live broadcast to on-demand unicast input by a user based on a rebroadcasting station, wherein the instruction for switching live broadcast to on-demand unicast comprises a name of an on-demand video and an episode number of the on-demand video, or also comprises definition and/or a type of the on-demand video; sending the instruction for switching live broadcast to on-demand unicast to a server, and indicating the server to return on-demand video parameters according to the instruction for switching live broadcast to on-demand unicast, wherein the on-demand video parameters comprise a play Uniform Resource Locator URL of a corresponding on-demand video; and after the on-demand video parameters are acquired, playing the corresponding on-demand video according to the on-demand video parameters.

According to the method and electronic device for switching live broadcast to on-demand unicast, provided by the embodiments of the present disclosure, an accurate play URL of an on-demand video can be acquired from the server side by sending an instruction for switching live broadcast to on-demand unicast, which includes the name of the on-demand video and the episode number of the on-demand video to the server side, and then the on-demand video is played. According to the method, only a one-step operation is needed to ensure that the client terminal can obtain a corresponding on-demand video from the server and can quickly and accurately switch to on-demand play content, the operation is simple, and the switching efficiency can be improved. By determining the current play identification, whether to play the on-demand video or not can be determined according to the needs of a user, the interaction process between the user and a player is simple, the needs of the user can be met without complicated operation, and the switching efficiency can be improved at the same time.

Other characteristics and advantages of the present disclosure will be stated in the follow-up description, and partially become apparent from the description, or will be understood by implementation of the present disclosure. The object and other advantages of the present disclosure can be achieved and obtained through the structures specified in the written description, claims, and drawings.

Hereinafter, the technical solution of the present disclosure will be further described in details through the drawings and embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of the first step of the method for switching live broadcast to on-demand unicast in the prior art;

FIG. 2 is a schematic diagram of the second step of the method for switching live broadcast to on-demand unicast in the prior art;

FIG. 3 is a schematic diagram of the third step of the method for switching live broadcast to on-demand unicast in the prior art;

FIG. 4 is a schematic diagram of the fourth step of the method for switching live broadcast to on-demand unicast in the prior art;

s FIG. 5 is a flow diagram of a method for switching live broadcast to on-demand unicast on the client side in an embodiment of the present disclosure;

FIG. 6 is a flow diagram of a method for switching live broadcast to on-demand unicast on the client side in the embodiment 1;

FIG. 7 is a flow diagram of a method for switching live broadcast to on-demand unicast at a server side in an embodiment of the present disclosure;

FIG. 8 is a flow diagram of the method for switching live broadcast to on-demand unicast at the server side in the embodiment 2;

FIG. 9 is a first structure diagram of a client for switching live broadcast to on-demand unicast in an embodiment of the present disclosure;

FIG. 10 is a second structure diagram of a client for switching live broadcast to on-demand unicast in an embodiment of the present disclosure;

FIG. 11 is a structure diagram of a server for switching live broadcast to on-demand unicast in an embodiment of the present disclosure;

FIG. 12 is a structure block diagram of a client for switching live broadcast to on-demand unicast in an embodiments of the present disclosure.

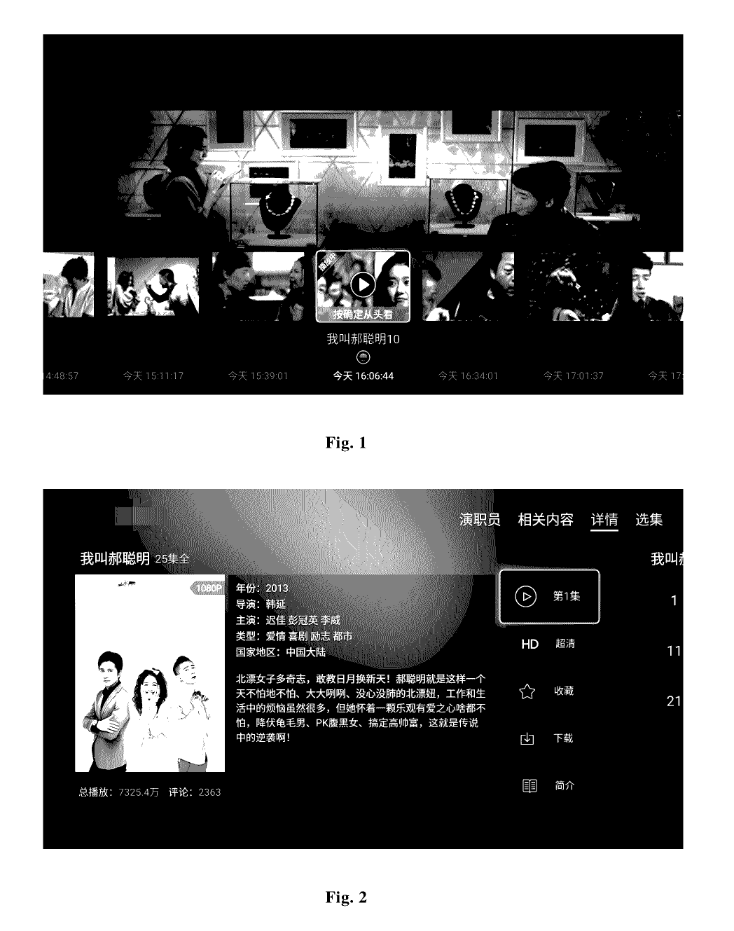

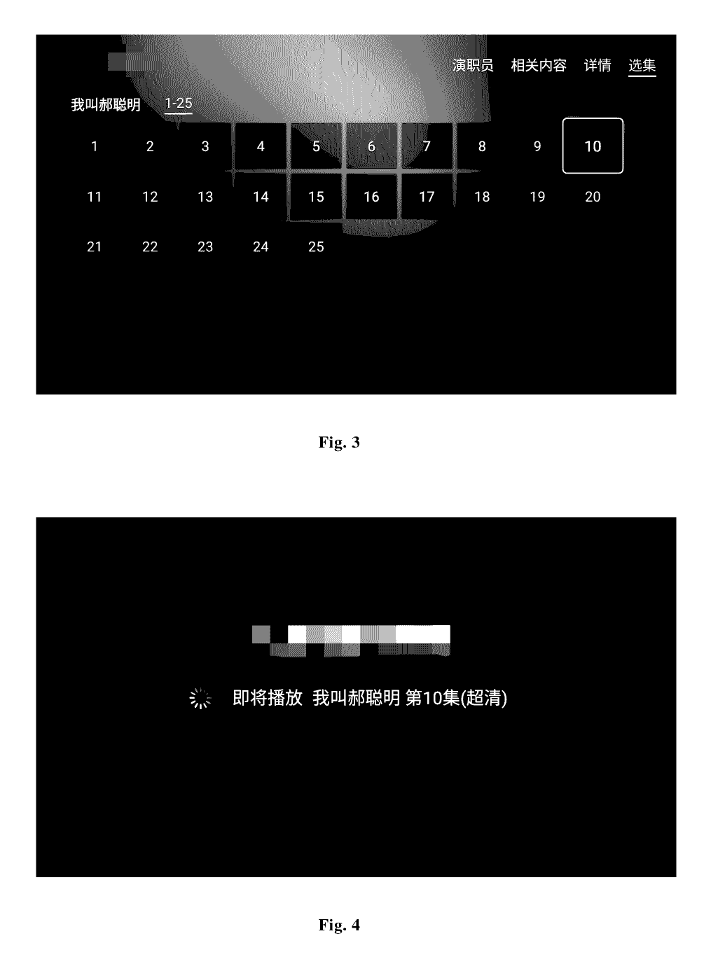

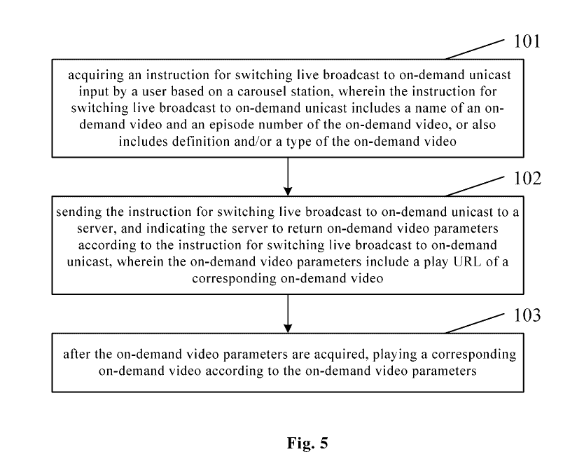

### DETAILED DESCRIPTION

Hereinafter, the specific embodiments of the present disclosure will be described in details with reference to the drawings, but it should be appreciated that the scope of the present disclosure is not restricted by the specific embodiments.

According to an embodiment of the present disclosure, a method for switching live broadcast to on-demand unicast at a client side is provided, and as shown in FIG. 5, the method includes steps 101-103:

S101: an instruction for switching live broadcast to on-demand unicast input by a user based on a rebroadcasting station is acquired, wherein the instruction for switching live broadcast to on-demand unicast includes a name of an on-demand video and an episode number of the on-demand video, or also includes definition and/or a type of the on-demand video.

In the embodiment of the present disclosure, the instruction for switching live broadcast to on-demand unicast, required to be sent to a server side, includes a name of an on-demand video and an episode number of the on-demand video, so that the server can accurately locate the video and the episode number that the user needs to watch according to the name of the on-demand video and the episode number. Specifically, the user needs to select a wanted on-demand video program at first, and then sends an instruction by operating a remote controller (for example, pressing an OK button), and a local device or player can determine the name of the on-demand video and the episode number of the on-demand video in the instruction for switching live broadcast to on-demand unicast according to the program selected by the user.

It should be noted that, the “episode number of the on-demand video” in the embodiment of the present disclosure is used for determining the only video in the videos related to the name of the on-demand video. Specifically, the episode number of the on-demand video may be the episode number of a television play (a certain episode of the television play, for example, the 10^{th} episode), or the e session number of a television program (a certain session of a television program, for example, the session on Sep. 27, 2015), or the release time of a movie (for example, some movies have the same names, and they can be distinguished according to release time or other information), etc.

Optionally, the instruction for switching live broadcast to on-demand unicast may also include definition, used for selecting a required definition from videos in various definition formats. When the instruction for switching live broadcast to on-demand unicast does not include the definition, the server returns an on-demand video with certain definition by default, or returns an on-demand video with the definition which best fits the network state of the client according to the network state of the client.

Optionally, the instruction for switching live broadcast to on-demand unicast may also include a type of the on-demand video, and the type of the on-demand video specifically includes television play, movie, variety show, documentary film, etc. On one hand, the server can distinguish and eliminate the programs with the same video names in other types of the on-demand video according to this type of the on-demand video; and on the other hand, the server can narrow the searching scope according to this type of the on-demand video, that is to say, the on-demand video required by the user is only searched in a corresponding on-demand video type set.

S102: the instruction for switching live broadcast to on-demand unicast is sent to the server to indicating the server to return on-demand video parameters according to the instruction for switching live broadcast to on-demand unicast, wherein the on-demand video parameters include a play Uniform Resource Locator (URL) of a corresponding on-demand video.

In the embodiment of the present disclosure, the client can determine the instruction for switching live broadcast to on-demand unicast according to operations of the user, then the instruction for switching live broadcast to on-demand unicast can be sent to the server, and when the server returns a play URL of a corresponding on-demand video, the video can be played according to the play URL (Uniform Resource Locator).

Optionally, the on-demand video parameters may also include an opening position of the on-demand video (title of the on-demand video), so that the user can conveniently skip the opening position through the client, and then directly watch the body part of the on-demand video.

S103: after the on-demand video parameters are acquired, the corresponding on-demand video is played according to the on-demand video parameters.

Specifically, the client plays the corresponding on-demand video according to the play URL in the on-demand video parameters.

According to the method for switching live broadcast to on-demand unicast on the client side, provided by the embodiment of the present disclosure, an accurate play URL of an on-demand video can be acquired from the server side by sending an instruction for switching live broadcast to on-demand unicast including the name of the on-demand video and the episode number of the on-demand video to the server side, and then the on-demand video is played. According to the method, only a one-step operation is needed to ensure that the client can obtain a corresponding on-demand video from the server and can quickly and accurately switch to on-demand play content, the operation is simple, and the switching efficiency can be improved.

Optionally, playing a corresponding on-demand video according to the on-demand video parameters in S103 specifically includes steps A1-A3.

Step A1: a current play identification is acquired, wherein the current play identification is used for indicating whether the client lively broadcasts the on-demand video or not after acquiring the on-demand video parameters.)

Step A2: when the current play identification is used for indicating the client terminal to lively broadcast the on-demand video, the play start time of the on-demand video and the current time is acquired, and the elapsed time of the on-demand video is determined according to the play start time of the on-demand video and the current time.

Step A3: the on-demand video is played at the elapsed time of the on-demand video.

Optionally, after the above-mentioned step A1, if the current play identification is used for indicating that the client does not lively broadcast the on-demand video, it goes to the step A4.

Step A4: the on-demand video is played at the start time of the on-demand time, or the on-demand video is played after skipping the opening position of the on-demand video, wherein the on-demand video parameters returned by the server include the opening position.

In the embodiment of the present disclosure, the current play identification is used for indicating whether the client lively broadcasts the on-demand video or not after acquiring the on-demand video parameters, namely indicating whether the client and the server synchronously play the on-demand video or not. Specifically, the current play identification can be represented by a status bit; for example, the status bit is divided into 0 and 1, the status bit 0 is used for representing that the current play identification is used for indicating that the client lively broadcasts the on-demand video, and the status bit 1 is used for representing that the current play identification is used for indicating that the client does not lively broadcast the on-demand video; or the status bit 1 is used for representing that the current play identification is used for indicating that the client lively broadcasts the on-demand video, and the status bit 0 is used for representing that the current play identification is used for indicating that the client does not lively broadcast the on-demand video.

Or, the current play identification can have an existence state and an inexistence state. When the current play identification exists, the client can acquire the current play identification, and at that moment, the current play identification indicates that the client lively broadcasts the on-demand video (which is equivalent to that the current play identification is used for indicating that the client lively broadcasts the on-demand video); and if the current play identification is in the inexistence state, the client cannot obtain the current play identification, or the current play identification acquired by the client is null, and at that moment, the client is indicated to carry out the above step A4 (which is equivalent to that the current play identification is used for indicating that the client does not lively broadcast the on-demand video).

According to the method for switching live broadcast to on-demand unicast, provided by the embodiment of the present disclosure, by determining the current play identification, whether to play the on-demand video or not can be determined according to the needs of a user, the needs of the user can be met without complicated operation, and the switching efficiency can be improved at the same time.

Hereinafter, the flow of the method for switching live broadcast to on-demand unicast on the client side will be described in details through an embodiment.

### Embodiment 1

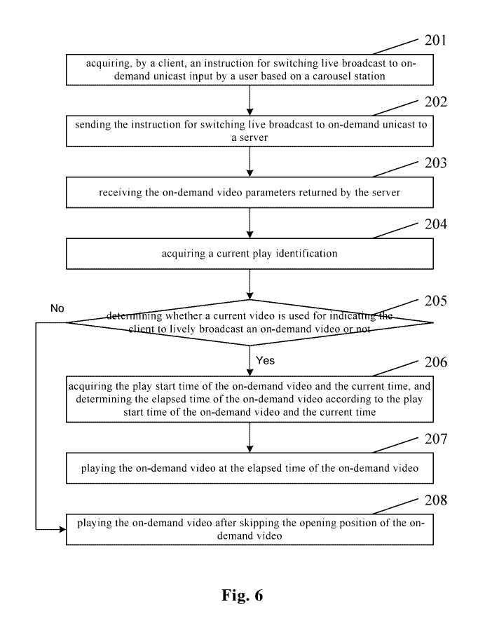

In the embodiment 1, a user can obtain a URL of an on-demand video by only sending an instruction for switching live broadcast to on-demand unicast through a client terminal by the steps 201-208 as shown in FIG. 6.

S201: a client terminal acquire an instruction for switching live broadcast to on-demand unicast input by the user based on a rebroadcasting station.

In the embodiment 1, the instruction for switching live broadcast to on-demand unicast includes the name of the on-demand video, and the episode number and definition of the on-demand video.

S202: the instruction for switching live broadcast to on-demand unicast is sent to a server.

After S202, the server will return the on-demand video parameters according to the instruction for switching live broadcast to on-demand unicast, and the on-demand video parameters include a play URL and the opening position of a corresponding on-demand video.

S203: the on-demand video parameters returned by the server are received.

S204: a current play identification is acquired.

In the embodiment 1, the current play identification is used for indicating whether the client lively broadcasts the on-demand video or not after acquiring the on-demand video parameters.

S205: the client terminal determines whether the current play identification is used for indicating the client lively broadcasts the on-demand video or not, and after determining that the current play identification is used for indicating the client to lively broadcast the on-demand video, continuing S206, or otherwise, continuing S208.

S206: the play start time of the on-demand video and the current time is acquired, and the elapsed time of the on-demand video is determined according to the play start time of the on-demand video and the current time.

Specifically, the elapsed time of the on-demand video is obtained by subtracting the play start time from the current time. For example, if the play start time of the on-demand video is 15:00:00 and the current time is 15:20:00, then the elapsed time of the on-demand video is 20 minutes, that is to say, the on-demand video has been played for 20 minutes.

S207: the on-demand video is played at the elapsed time of the on-demand video.

Specifically, taking the above example as an example, the on-demand video is started to be played at a 20-minute position of the timeline of the on-demand video.

S208: the on-demand video is played after skipping the opening position of the on-demand video.

Wherein, the opening position of the on-demand video can be determined according to the on-demand video parameters returned by the server.

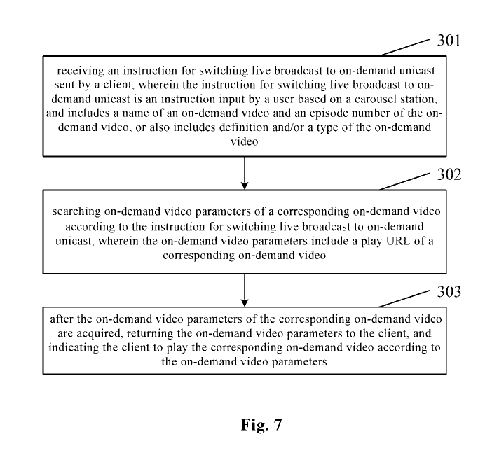

Based on the same inventive concept, an embodiment of the present disclosure also provide a method for switching live broadcast to on-demand unicast on a server side, and as shown in FIG. 7, the method includes steps 301-303.

S301: the server receives an instruction for switching live broadcast to on-demand unicast sent by a client, wherein the instruction for switching live broadcast to on-demand unicast is an instruction input by a user based on a rebroadcasting station, and includes a name of an on-demand video and an episode number of the on-demand video, or also includes definition and/or a type of the on-demand video.

S302: the server searches on-demand video parameters of a corresponding on-demand video according to the instruction for switching live broadcast to on-demand unicast, wherein the on-demand video parameters include a play URL of a corresponding on-demand video.

Specifically, the server can determine a collection of on-demand videos required to be searched according to the type of the on-demand video in the instruction for switching live broadcast to on-demand unicast, can accurately determine the on-demand video required by the user according to the name of the on-demand video and the episode number of the on-demand video, and can finally determine the URL of the on-demand video returned to the client according to the definition.

Optionally, the on-demand video parameters also include an opening position of the on-demand video. After acquiring the opening position, the client can directly play the body part of user interest by skipping the opening position of the on-demand video.

S303: after the on-demand video parameters of the corresponding on-demand video are acquired, the server returns the on-demand video parameters to the client, and indicates the client to play the corresponding on-demand video according to the on-demand video parameters.

According to the method for switching live broadcast to on-demand unicast on the server side, provided by the embodiment of the present disclosure, the on-demand video required by a user can be directly and accurately determined according to the instruction for switching live broadcast to on-demand unicast sent by the client, so that an accurate play URL of an on-demand video can be returned to the client, and then the on-demand video is played by the client. According to the method, only a one-step operation is needed to ensure that a link of a corresponding on-demand video can be sent to the client, the client can quickly and accurately switch to on-demand play content, the operation is simple, and meanwhile, the switching efficiency can be improved.

Hereinafter, the interaction process of the method for switching live broadcast to on-demand unicast through the client and the server will be described in details through embodiment 2.

### Embodiment 2

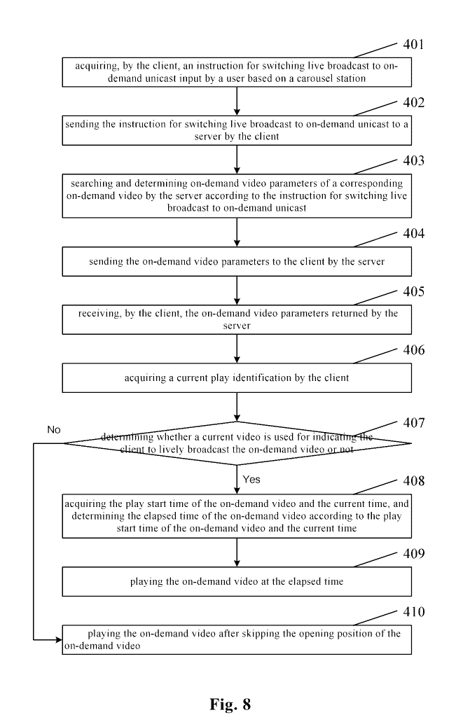

In the embodiment 2, a user can obtain a URL of an on-demand video by only sending an instruction for switching live broadcast to on-demand unicast through a client by the steps 401-410 as shown in FIG. 8.

S401: the client terminal acquires an instruction for switching live broadcast to on-demand unicast input by the user based on a rebroadcasting station.

In the embodiment 2, the instruction for switching live broadcast to on-demand unicast includes the name of the on-demand video, the episode number and definition of the on-demand video, and the type of the on-demand video.

S402: the client terminal send the instruction for switching live broadcast to on-demand unicast to a server by the client.

S403: the server searches and determining on-demand video parameters of a corresponding on-demand video, according to the instruction for switching live broadcast to on-demand unicast.

Specifically, in the embodiment 2, the on-demand video parameters include a play URL and an opening position of a corresponding on-demand video.

S404: the server sends the on-demand video parameters to the client.

S405: the client receives the on-demand video parameters returned by the server.

S406: the client acquires the current play identification.

In the embodiment 2, the current play identification is used for indicating whether the client lively broadcasts the on-demand video or not after acquiring the on-demand video parameters.

S407: the client determines whether the current play identification is used for indicating that the client lively broadcasts the on-demand video or not, and after determining that the current play identification is used for indicating the client to lively broadcasts the on-demand video, continuing S408, or otherwise, continuing S410.

S408: the client terminal acquires the play start time of the on-demand video and the current time, and determines the elapsed time of the on-demand video according to the play start time of the on-demand video and the current time.

S409: the client terminal plays the on-demand video at the elapsed time of the on-demand video.

S410: the client terminal plays the on-demand video after skipping the opening position of the on-demand video.

According to the method for switching live broadcast to on-demand unicast, provided by the embodiment of the present disclosure, an accurate play URL of an on-demand video can be acquired from the server side by sending an instruction for switching live broadcast to on-demand unicast including the name of the on-demand video and the episode number of the on-demand video to the server side, and then the on-demand video is played. According to the method, only a one-step operation is needed to ensure that the client can obtain a corresponding on-demand video from the server and can quickly and accurately switch to on-demand play content, the operation is simple, and the switching efficiency can be improved. By determining the current play identification, whether to play the on-demand video or not can be determined according to the needs of a user, the needs of the user can be met without complicated operation, and the switching efficiency can be improved at the same time.

The flow of the method for switching live broadcast to on-demand unicast is described above in details, the method may also be implemented by a corresponding device, and hereinafter, the structure and functions of the device will be described in details.

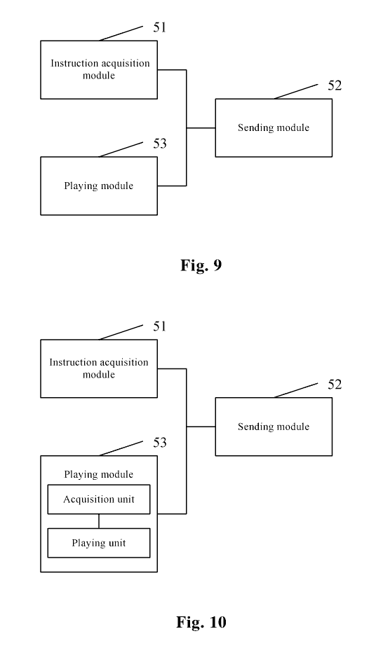

A client for switching live broadcast to on-demand unicast, provided by an embodiment of the present disclosure, as shown in FIG. 9, includes: an instruction acquisition module 51, a sending module 52, a playing module 53.

The instruction acquisition module 51 is used for acquiring an instruction for switching live broadcast to on-demand unicast input by a user based on a rebroadcasting station, wherein the instruction for switching live broadcast to on-demand unicast includes a name of an on-demand video, and an episode number and definition of the on-demand video, or also includes a type of the on-demand video;

The sending module 52 is used for sending the instruction for switching live broadcast to on-demand unicast to a server, and indicating the server to return on-demand video parameters according to the instruction for switching live broadcast to on-demand unicast, wherein the on-demand video parameters include a play URL of a corresponding on-demand video; and

The playing module 53 is used for, after the on-demand video parameters are acquired, playing the corresponding on-demand video according to the on-demand video parameters.

Optionally, as shown in FIG. 10, the playing module 53 specifically includes: an acquisition unit 531 and a playing unit 532.

The acquisition unit 531 is used for acquiring a current play identification, wherein the current play identification is used for indicating whether the client lively broadcasts the on-demand video or not after acquiring the on-demand video parameters.

The playing unit 532 is used for, when the current play identification is used for indicating that the client lively broadcasts the on-demand video, acquiring the play start time of the on-demand video and the current time, determining the elapsed time of the on-demand video according to the play start time of the on-demand video and the current time, and playing the on-demand video at the elapsed time of the on-demand video.

Optionally, when the current play identification is used for indicating that the client does not lively broadcast the on-demand video, the playing unit 532 is also used for: playing the on-demand video at the start time of the on-demand time; or playing the on-demand video after skipping the opening position of the on-demand video, wherein the on-demand video parameters returned by the server include the opening position.

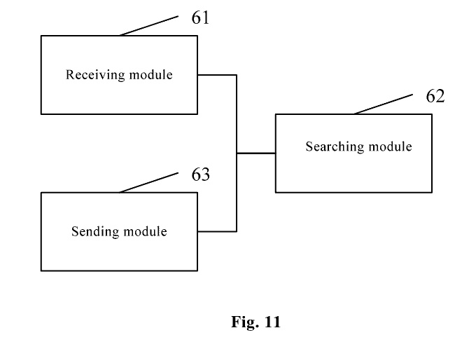

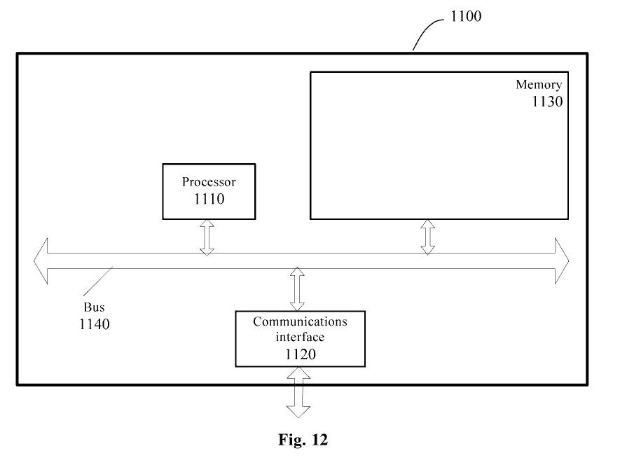

Based on the same inventive concept, an embodiment of the present disclosure also provide a server for switching live broadcast to on-demand unicast, and as shown in FIG. 11, the server includes: a receiving module 61, a searching module 62, a sending module 63.

The receiving module 61 is used for receiving an instruction for switching live broadcast to on-demand unicast sent by a client, wherein the instruction for switching live broadcast to on-demand unicast is an instruction input by a user based on a rebroadcasting station, and includes a name of an on-demand video, and an episode number and definition of the on-demand video, or also includes a type of the on-demand video.

The searching module 62 is used for searching on-demand video parameters of a corresponding on-demand video according to the instruction for switching live broadcast to on-demand unicast, wherein the on-demand video parameters include a play URL of a corresponding on-demand video.

The sending module 63 is used for, after the on-demand video parameters of the corresponding on-demand video are acquired, returning the on-demand video parameters to the client, and indicating the client to play the corresponding on-demand video according to the on-demand video parameters.

Optionally, the on-demand video parameters also include an opening position of the on-demand video.

According to the method and electronic device for switching live broadcast to on-demand unicast, provided by the embodiments of the present disclosure, an accurate play URL of an on-demand video can be acquired from the server side by sending an instruction for switching live broadcast to on-demand unicast including the name of the on-demand video and the episode number of the on-demand video to the server side, and then the on-demand video is played. According to the method, only a one-step operation is needed to ensure that the client can obtain a corresponding on-demand video from the server and can quickly and accurately switch to on-demand play content, the operation is simple, and the switching efficiency can be improved. By determining the current play identification, whether to play the on-demand video or not can be determined according to the needs of a user, the interaction process between the user and a player is simple, the needs of the user can be met without complicated operation, and the switching efficiency can be improved at the same time.

FIG. 12 shows a structure block diagram of an electronic device for switching live broadcast to on-demand unicast in another embodiment of the present disclosure. The client 1100 may be a host server with a computing function, a personal computer (PC), or a portable computer or terminal or the like. The specific embodiments of the present disclosure do not define the specific implementation of a computing node.

The electronic device 1100 includes a processor 1110, a communications interface 1120, a memory (memory array) 1130 and a bus 1140, wherein the processor 1110, the communications interface 1120 and the memory 1130 achieve intercommunication through the bus 1140.

The communications interface 1120 is used for communication with a network element, wherein the network element includes, for example, a virtual machine management center, a shared storage and the like.

The processor 1110 is used for executing a program. The processor 1110 may be a central processing unit (CPU), or an ASIC (Application Specific Integrated Circuit), or one or more integrated circuits configured to implement the embodiment of the present disclosure.

The memory 1130 is used for storing files. The memory 1130 may include a high-speed RAM memory, and may also include a non-volatile memory, for example, at least one disk memory. The memory 1130 may also be a memory array. The memory 1130 may also be partitioned into blocks, and the blocks may be combined into a virtual volume according to a certain rule.

In a possible embodiment, the above-mentioned program may be a program code including a computer operation instruction. The program, specifically, may be used for: acquiring an instruction for switching live broadcast to on-demand unicast input by a user based on a rebroadcasting station, wherein the instruction for switching live broadcast to on-demand unicast includes a name of an on-demand video and an episode number of the on-demand video, or also includes definition and/or a type of the on-demand video; sending the instruction for switching live broadcast to on-demand unicast to a server, and indicating the server to return on-demand video parameters according to the instruction for switching live broadcast to on-demand unicast, wherein the on-demand video parameters include a play URL of a corresponding on-demand video; and after the on-demand video parameters are acquired, playing the corresponding on-demand video according to the on-demand video parameters.

In the above technical solution, playing a corresponding on-demand video according to the on-demand video parameters includes: acquiring a current play identification, wherein the current play identification is used for indicating whether the client lively broadcasts the on-demand video or not after acquiring the on-demand video parameters; when the current play identification is used for indicating that the client lively broadcasts the on-demand video, acquiring the play start time of the on-demand video and the current time, and determining the elapsed time of the on-demand video according to the play start time of the on-demand video and the current time; and playing the on-demand video at the elapsed time of the on-demand video.

In the above technical solution, when the current play identification is used for indicating that the client does not lively broadcast the on-demand video, the following step will be executed: playing the on-demand video at the start time of the on-demand time; or playing the on-demand video after skipping the opening position of the on-demand video, wherein the on-demand video parameters returned by the server include the opening position.

The embodiment of the present invention provides a non-transitory computer-readable storage medium storing executable instructions that, when executed by an electronic device, cause the electronic device to execute the processing method in the case of any method embodiment mentioned above.

The present disclosure may have various specific embodiments in different forms, the technical solution of the present disclosure is illustrated above by taking FIG. 5-FIG. 13 as examples with reference to the drawings, and this does not mean that the specific examples applied to the present disclosure can only be limited to specific processes or embodiment structures; and it will be appreciated by those skilled in the art that the above-mentioned specific embodiments are just some examples of a variety of preferred usages, and any embodiment embodying the claims of the present disclosure shall be in the scope claimed by the technical solution of the present disclosure.

Finally, it should be noted that, what mentioned above are only preferred embodiments of the present disclosure, and are not used for limiting the present disclosure; and although the present disclosure is described in details with reference to the above-mentioned embodiments, those skilled in the part still can modify the technical solution recorded by the above-mentioned embodiments, or take equivalents to part of the technical features therein. Within the spirit and principle of the present disclosure, any modification, equivalents, improvement, etc. shall be included in the protection scope of the present disclosure.

What is claimed is:

1. A method for switching live broadcast to on-demand unicast, at an electronic device, the method comprising:
acquiring an instruction for switching live broadcast to on-demand unicast input by a user based on a rebroadcasting station, wherein the instruction for switching live broadcast to on-demand unicast comprises a name of an on-demand video and an episode number of the on-demand video, or also comprises definition and/or a type of the on-demand video;
sending the instruction for switching live broadcast to on-demand unicast to a server, and indicating the server to return on-demand video parameters according to the instruction for switching live broadcast to on-demand unicast, wherein the on-demand video parameters comprise a play Uniform Resource Locator URL of a corresponding on-demand video; and
after the on-demand video parameters are acquired, playing the corresponding on-demand video according to the on-demand video parameters.

2. The method according to claim 1, wherein, the playing a corresponding on-demand video according to the on-demand video parameters comprises:
acquiring a current play identification, wherein the current play identification is used for indicating whether the client terminal lively broadcasts the on-demand video or not after acquiring the on-demand video parameters;
when the current play identification is used for indicating the client terminal to lively broadcast the on-demand video, acquiring a play start time of the on-demand video and the current time, and determining the elapsed time of the on-demand video according to the play start time of the on-demand video and the current time; and
playing the on-demand video at the elapsed time of the on-demand video.

3. The method according to claim 2, wherein, when the current play identification is used for indicating the client not to lively broadcast the on-demand video, comprising:
playing the on-demand video at the start time of the on-demand time; or
playing the on-demand video after skipping an opening position of the on-demand video, wherein the on-demand video parameters returned by the server comprises the opening position of the on-demand video.

4. An electronic device, comprising:
at least one processor; and
a memory communicably connected with the at least one processor for storing instructions executable by the at least one processor, wherein execution of the instructions by the at least one processor causes the at least one processor to:
acquire an instruction for switching live broadcast to on-demand unicast input by a user based on a rebroadcasting station, wherein the instruction for switching live broadcast to on-demand unicast comprises a name of an on-demand video and an episode number of the on-demand video, or also comprises definition and/or a type of the on-demand video;
send the instruction for switching live broadcast to on-demand unicast to a server, and indicating the server to return on-demand video parameters according to the instruction for switching live broadcast to on-demand unicast, wherein the on-demand video parameters comprise a play Uniform Resource Locator URL of a corresponding on-demand video; and
after the on-demand video parameters are acquired, play the corresponding on-demand video according to the on-demand video parameters.

5. The electronic device according to claim 4, wherein, execution of the instructions by the at least one processor causes the at least one processor to:
acquire a current play identification, wherein the current play identification is used for indicating whether the client terminal lively broadcasts the on-demand video or not after acquiring the on-demand video parameters;
when the current play identification is used for indicating the client terminal to lively broadcast the on-demand video, acquiring a play start time of the on-demand video and the current time, and determine the elapsed time of the on-demand video according to the play start time of the on-demand video and the current time; and
playing the on-demand video at the elapsed time of the on-demand video.

6. The electronic device according to claim 5, wherein, execution of the instructions by the at least one processor causes the at least one processor to:
play the on-demand video at the start time of the on-demand time; or
play the on-demand video after skipping an opening position of the on-demand video, wherein the on-demand video parameters returned by the server comprises the opening position of the on-demand video.

7. A non-transitory computer-readable storage medium storing executable instructions that, when executed by an electronic device, cause the electronic device to:
acquire an instruction for switching live broadcast to on-demand unicast input by a user based on a rebroadcasting station, wherein the instruction for switching live broadcast to on-demand unicast comprises a name of an on-demand video and an episode number of the on-demand video, or also comprises definition and/or a type of the on-demand video;
send the instruction for switching live broadcast to on-demand unicast to a server, and indicating the server to return on-demand video parameters according to the instruction for switching live broadcast to on-demand unicast, wherein the on-demand video parameters comprise a play Uniform Resource Locator URL of a corresponding on-demand video; and
after the on-demand video parameters are acquired, play the corresponding on-demand video according to the on-demand video parameters.

8. The non-transitory computer-readable storage medium storing executable instructions according to claim 7, wherein, execution of the instructions cause the electronic device to:
acquire a current play identification, wherein the current play identification is used for indicating whether the client terminal lively broadcasts the on-demand video or not after acquiring the on-demand video parameters;
when the current play identification is used for indicating the client terminal to lively broadcast the on-demand video, acquire a play start time of the on-demand video and the current time, and determine the elapsed time of the on-demand video according to the play start time of the on-demand video and the current time; and
play the on-demand video at the elapsed time of the on-demand video.

9. The non-transitory computer-readable storage medium storing executable instructions according to claim 8, wherein, execution of the instructions cause the electronic device to:
play the on-demand video at the start time of the on-demand time; or
play the on-demand video after skipping an opening position of the on-demand video, wherein the on-demand video parameters returned by the server comprises the opening position of the on-demand video.
